(19) United States
(12) Patent Application Publication
(10) Pub. No.: US 2015/0046371 A1
(43) Pub. Date: Feb. 12, 2015

(54) SYSTEM AND METHOD FOR DETERMINING SENTIMENT FROM TEXT CONTENT

(71) Applicant: CBS Interactive Inc., San Francisco, CA (US)

(72) Inventor: Adam Leary, San Francisco, CA (US)

(21) Appl. No.: 14/487,005

(22) Filed: Sep. 15, 2014

Related U.S. Application Data
(63) Continuation-in-part of application No. 13/098,302, filed on Apr. 29, 2011, now Pat. No. 8,838,438.

(51) Int. Cl. G06Q 30/02; G06F 17/27

(52) U.S. Cl. CPC G06Q 30/0282; G06F 17/27
USPC 705/347

(57) ABSTRACT

User-generated content is processed from multiple online sources. A sentiment value is determined for a subject based on the user-generated content from the multiple online sources. The sentiment value can be determined by associating a weight with at least a first online source of the multiple online sources. An output can be generated for the sentiment value.

### RELATED APPLICATIONS

This application is a continuation-in-part of U.S. patent application Ser. No. 13/098,302, entitled “SYSTEM AND METHOD FOR DETERMINING SENTIMENT FROM TEXT CONTENT,” filed Apr. 29, 2011, hereby incorporated by reference in its entirety.

### TECHNICAL FIELD

Embodiments described herein pertain to content analysis, and more particularly, to a system and method for determining sentiment from analysis of content.

### BACKGROUND

Online mediums currently provide various forums by which individuals can provide feedback, commentary and social marking. For example, various websites employed like/follow functionality to enable users to mark an online item they like or are interested in. Commentary forums (e.g. message boards) also exist to enable users to express feedback, usually in the context of some other content, such as a review or news item. Additionally, functionality exists to enable users to share content or information that is of interest to them.

### BRIEF DESCRIPTION OF THE DRAWINGS

FIG. 1 illustrates a system architecture for performing sentiment analysis on text content, according to one or more embodiments.

FIG. 2 illustrates a method for determining sentiment from user generated text content, according to one or more embodiments.

FIG. 3 illustrates a method for determining sentiment value of text content generated pertaining to particular subjects.

FIG. 4 illustrates a sentiment determination for predetermined categories that are relevant to a domain and subject, according to one or more embodiments.

FIG. 5 illustrates a sentiment determination for subjects of a given domain, according to another embodiment.

FIG. 6 illustrates a presentation generated to provide the terminations of sentiment value in context of individual subjects, according to one or more embodiments.

FIG. 7 illustrates a system for determining a populace sentiment of a given subject, according to some embodiments.

FIG. 8 illustrates a method for determining a populace sentiment, according to some embodiments.

FIG. 9 is a block diagram that illustrates a computer system upon which embodiments described herein may be implemented.

### DETAILED DESCRIPTION

Embodiments described herein include a system and method for determining sentiment expressed in user-generated text content.

In particular, embodiments described herein recognize the increased presence of user-generated text content on websites and online mediums, such as social networking sites and user-review sites. In contrast to some conventional online techniques which enable the user to express like/dislike by rating, voting or liking/following a particular item, embodiments described herein measure sentiment by analyzing the terms (e.g. words or word pairs), clauses and sentences that are present in the text content. Thus, embodiments provide that the user sentiment is deciphered from words, expressions and clauses the user employs to convey their thoughts.

Sentiment analysis, as described by numerous embodiments herein, may be implemented in a variety of contexts. Embodiments such as described herein may implement sentiment analysis to gauge user sentiment in the context of, for example, reviews and/or discussions of restaurants, wines, food (e.g. recipes, fine foods for sale), forum discussions on cooking and the like. Sentiment analysis may also be performed for user reviews and discussion on various other topics, such as books, movies, television (or radio programs), websites or online content, politics, product reviews. Still further, some embodiments may implement sentiment analysis to gauge user sentiment in relation to messages (e.g. email) or commentary composed by a user, or by a population of users. Embodiments described may be implemented to determine sentiment and content for publicly available user-generated content. Alternatively, the sentiment determination may be made available only to those viewers who are privy to view content generated from a particular user.

Under one embodiment, user-generated text content is analyzed to determine a sentiment value that a user expresses for a subject (e.g. topic, place or thing). The sentiment value may be multidimensional, in that it may reflect sentiment for different characteristics or aspects of the subject. The sentiment value may be based at least in part on sentiment scores associated with individual words that the user used.

Still further, to one or more embodiments, one or more subject terms, domain category terms and sentiment terms are identified from a user-generated text content. A determination is made as how each of the one or more sentiment terms is relevant to the one or more subject terms and/or the domain category terms. A sentiment score is determined for each of the sentiment terms. A sentiment value is determined for a subject identified by the subject term. The sentiment value of the subject may be based on one or more sentiment scores for sentiment terms that are determined to be relevant to the one or more subject terms and/or the one or more domain category terms

Among other advantages, embodiments described herein can also measure an intensity of the user's sentiment (e.g. how much the user's likes something). For example, the degree of enthusiasm or disgust a particular user has for a particular subject can be measured from sentiment analysis, as described herein.

According to some embodiments, user-generated text content is analyzed in order to determine a sentiment that the author expresses as to a particular subject of the content. The sentiment may be programmatically determined and quantified to represent a particular sentiment such as like/dislike, as well intensity of the sentiment.

As described with some examples, the context of the user-generated text content may correspond to reviews of business establishments and products. The sentiment that is deciphered from the terms and expressions used by the author may be applied to understand the sentiment the user has for the establishment or product.

With content such as user-reviews, embodiments further recognize that the user's sentiment may vary for different aspects of the user's experience. For example, with products or service, the user's sentiment may vary as to the product/service, price and overall experience.

According to some embodiments, the sentiment can be determined from words, terms and expressions the user employed. Furthermore, the relevance or applicability of the words to a subject or its characteristic can be determined from grammatical analysis of the text content.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Architecture

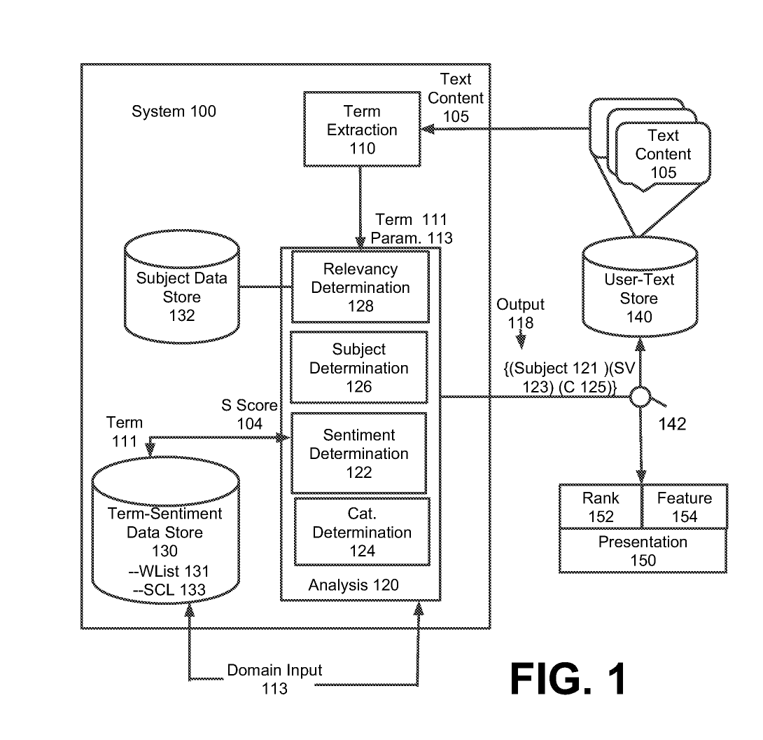

FIG. 1 illustrates a system architecture for performing sentiment analysis on text content, according to one or more embodiments. A sentiment determination system 100 is comprised of components that include term extraction 110 to identify salient terms from user generated text content 105, and analysis component 120 to determine a sentiment value for the user generated text content 105 based in part on the presence of terms in the content.

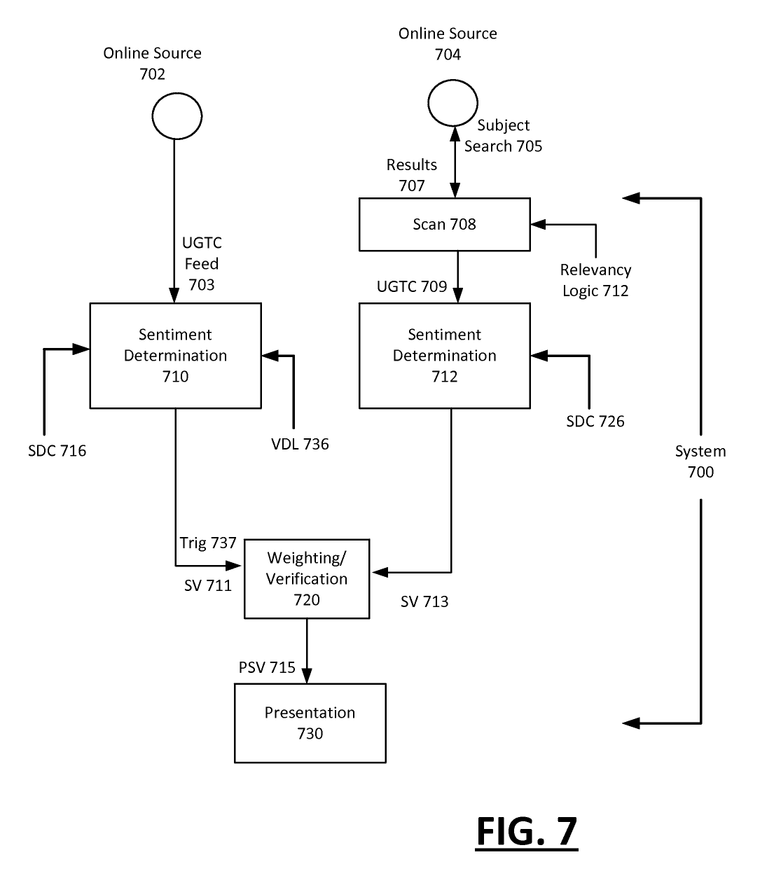

According to some embodiments, the system 100 can be implemented by a server, or a combination of servers. However, other non-server computing environments can alternatively be used. For example, the system 100 may be implemented on a single user terminal, or in a networked environment of shared resources were individual computers communicate by way of, for example, client/server or peer to peer connections. FIG. 7 illustrates a computer system for implementing embodiments such as described with FIG. 1.

In some implementations, system 100 may be implemented as a service. In particular, system 100 may include a programmatic interface to respond to function call requests from other applications or sites that specify text content 105. The system 100 includes programmatic components for performing functions that operate on the text, including functions for tokenizing the text content, analyzing the grammatical structure of the text, and identifying sentiment and subject from the text.

According to an embodiment, term extraction 110 processes user generated text content 105 from a particular resource or location. In the example shown, a user generated text content store 140 retains text content 105 that is analyzed by the system 100. The text content store 140 may maintain user generated text content 105 in the form of, for example, user reviews of business establishments and products, social networking content, commentary, and/or blog entries. Alternatively, the text content 105 may be generated or retrieved on the fly by a retrieval or submission process. Term extraction 110 tokenizes the content 105 into individual terms. The term extraction 110 may identify, from a given text content 105, a set of terms 111, as well as parameters 113 for utilizing the terms 111 for sentiment analysis. The terms 111 may correspond to probative terms that can be used to identify sentiment or subject from the text content. The parameters 113 may include contextual data or metadata for use in making subject/sentiment determinations.

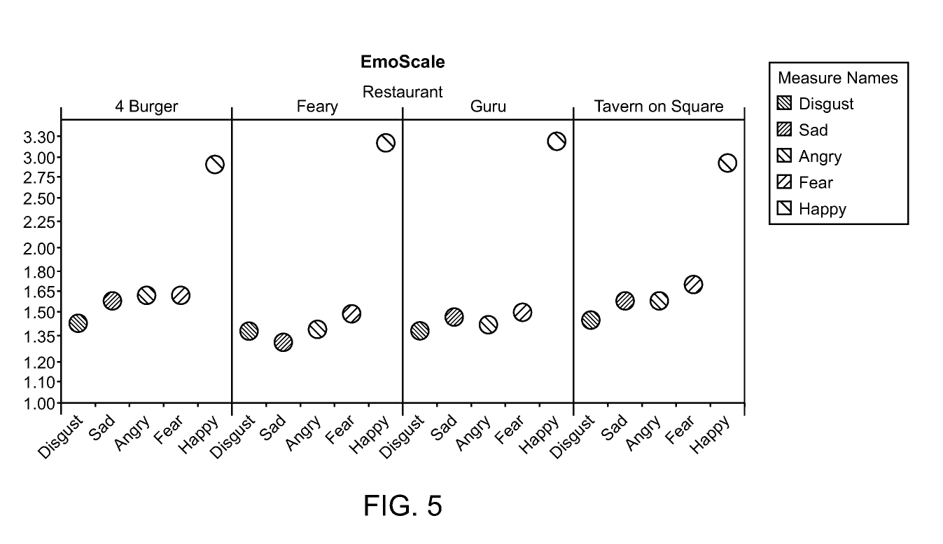

The analysis component 120 performs functions for identifying sentiment and subject (or entity) from the text content 105. The analysis component 120 may also include a component for determining sentiment category, as detailed below. In one embodiment, the analysis component 120 comprises subcomponents that include term sentiment determination 122, sentiment category determination 124, subject determination 126 and relevancy analysis 128. The term sentiment determination 122 identifies a pre-determined sentiment score 104 assigned to individually extracted terms 111 of the text content 105. According to some embodiments, individual terms that are deemed to carry sentiment may be predefined and associated with a corresponding sentiment score. In one embodiment, the sentiment score 104 is singular in dimension and correlates to an intensity or degree of a particular sentiment, such as happiness/unhappiness of the user (e.g. the amount the user likes something). In other embodiments, the sentiment score 104 of a particular term is mufti-dimensional, and may correspond to a continuum of affects or emotion, such as fear, anger, and like/dislike. For example, as shown with an embodiment of FIG. 5, multiple types of sentiment may be identified and scored from a single text content. Still further, in some variations, the sentiment score 104 may be limited in range, such as provided by the following examples: (i) positive or negative; or (ii) positive, negative, or neutral. Still further, the sentiment score 104 may correspond to a number that is between a range, or a discrete set of numbers between such range (e.g. rating of 1 to 5).

The sentiment score 104 for individually extracted terms 111 of a given item of text content 105 may be stored in a term sentiment data store 130. In some embodiments, the term-sentiment data store 130 maintains (i) a word list 131, and (ii) a list of pre-determined sentiment scores 133 for individual entries of the word list 131. The contents of the data store (e.g. word list 131) may be domain specific. Thus, multiple word lists 131 and associated sentiment scores can be maintained for different domains of subjects. The terms 111 extracted from the text content 105 can be compared against the word list 131 to identify a corresponding sentiment score 104 as provided by the sentiment score list 133. The word list 131 and sentiment score list 133 can be built or developed from a variety of sources, such as manual input.

As an alternative or addition, some or all of the entries of the word list 131 and/or sentiment score list 133 may be programmatically determined. For example, text content from a particular set of sources may be scraped for terms and expressions. Additionally, the terms and expressions may be associated with a sentiment by analyzing or identifying a ranking or rating associated with the content. In one implementation, initialization files are created for a particular domain. The preliminary initialization files may be created by clustering a sample of the text based on key concepts that are identified (e.g. manually) identified as being part of the ontology of attitude or entities. Once established, editors or additional programmatic input may be used to tune the word lists and associated values.

In utilizing predetermined scores for entries of the word list, embodiments recognize that various influences may affect the accuracy of understanding the sentiment. For example, a term in one context may have a positive sentiment, while in another context, it may have a negative sentiment. For example, the term “rich” may have a slightly negative connotation when used to describe food, and a more positive connotation when referring to a literary work.

Furthermore, some embodiments recognize that many factors can affect the sentiment carried by a particular term. In particular, the domain of the user generated text content 105 can greatly influence both (i) the contents of the word list, and (ii) the sentiment associated with individual terms of the word list. Accordingly, the term-sentiment data store 130 may include domain specific parameters 113, which can identify the word-list 131 (from among multiple possibilities), or alternatively entries of word-lists 131 for the particular domain. The domain specific parameters 113 can identify the context of the text content 105 which is analyzed. For example, domain specific parameters may be defined from a website from which text content is scraped. Such text content may correspond to reviews of restaurants, foods, or wines is provided, and the domain specific parameters may include (i) words used in restaurant/food reviews (e.g. website jargon), and (ii) sentiment derived from word definitions and uses that are specific to restaurant/food reviews.

Additionally, the semantic context of a particular word or term is relevant. In one embodiment, pairings are used to identify whether a sentiment is inferred from a particular term. Analyzing Word pairing can offer a more accurate sentiment analysis than the individual words.

Embodiments also recognize that the semantic context determined for a particular content 105 is typically pertinent to a particular subject, such as a business establishment, service and/or product. In some embodiments, the term extraction 110 extracts terms 111 that are potential subjects of the user content and sentiment. For example, the subject of the user content 105 may correspond to, for example, a business establishment or commercial product. In this example, the analysis component 120 may include a subject determination component 126 that determines the subject (e.g. restaurant, food product or service, etc.) from the extracted terms 111. In some embodiments, the subject determination 126 can incorporate a subject data store 132, which may include a list of potential subjects for a given domain. For example, on a food website, the subject list may include names of restaurants or food establishments, or alternatively, of food products (e.g. wines).

Additionally, in some embodiments, the analysis component 120 includes a sentiment category determination 124 that identifies a category for the user sentiment as it applies to the subject. The category determination 124 may identify, for example, facets of the user experience which can have a different user sentiment. For example, in a user restaurant review, the user may have different sentiments about the food, the service, the price, the ambiance, and the overall experience. The category determination 124 may identify terms that indicate the content is pertinent to a domain category (e.g. restaurant pricing).

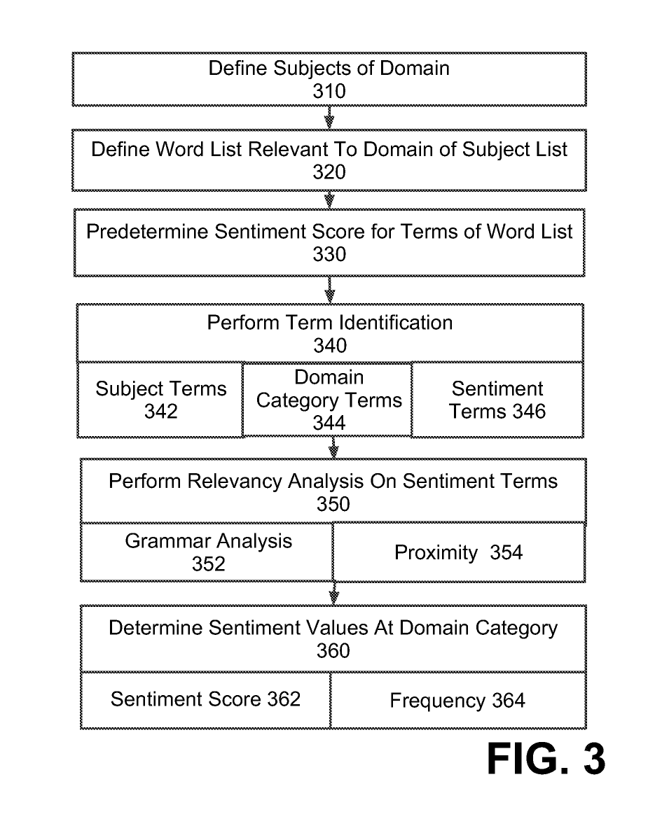

In some embodiments, relevancy analysis 128 is used to identify, with some precision, the relevance of terms of sentiment (as determined by sentiment determination 122) to subject (as determined by subject determination 126) or categories (as determined by category determination 124). Relevancy analysis may use various metrics and/or algorithms (such as described with steps of FIG. 3) to determine the relevancy of particular terms of sentiment to subject or subject category. For example, if the user expresses a term of positive sentiment, the relevancy analysis 128 may be used to determine whether the sentiment was for a particular domain category (e.g. the user liked the price). Relevancy analysis 128 may use, for example, word pairing (as described below), proximity of sentiment term to subject term or category term, rules and grammatical analysis (e.g. clausal analysis, as described below).

The analysis component 120 generates an output 118 comprising one or more sentiment values 123 for a given item of user text content 105. The output 118 may also identify the subject 121 of the user text content 105, as well as one or more subject or domain specific categories 125 that can be the focus of user sentiment. The terms of sentiment may be associated with subject terms or domain category terms.

The output 118 of the analysis component 120 can be stored in, for example, data store 140. In one embodiment, the output 118 is an interactive display of the text content 105, with tagged results corresponding to sentiment and/or subject (e.g. an html format). In some implementations, the output 118 may be generated from a batch process in which multiple text content 105 is analyzed. The results may be communicated to other sites, presented and/or stored in databases for subsequent use and/or presentation.

The determined sentiment value(s) 123 may be stored in association with the user text content 105 and represent what is determined to be sentiment for the subject. After analysis, the given user text content 105 may be associated with sentiment value 123 that correlates to (i) the users sentiment for a particular facet or category of the subject in the user content (e.g. business establishment), and/or (ii) the users sentiment in general, on average, or overall when all facets and categories are considered. The sentiment value(s) 123 that is determined for the particular item of user text content 105 may be based on the sentiment score 104 for salient terms 111 that are relevant to the subject and or the subject categories. For example, the sentiment score 104 for individual terms that are extracted from the text content may be averaged (or categorized and then averaged), in order to determine sentiment for the subject and/or a particular predefined domain-relevant category. Thus, for a given item of user content 105, the sentiment value 123 may be based on the sentiment score 104 of multiple salient terms 111 that appear in the content. Various algorithmic considerations may be employed in determining the sentiment value 123. The sentiment value 123 may correspond to a number range. Alternatively, the sentiment value 123 may correspond to a discrete set of numbers (e.g. 1 to 5). As another variation, the sentiment value may correspond to a finite or limited value, such as positive/negative, or positive/neutral/negative.

In some implementations, domain specific parameters 113 may also influence the determination of the output 118, including the determination of the sentiment values 123, as well as determination of the subject category determination. The manner in which the sentiment values are calculated based on the sentiment scores 104 of individual salient terms may also be affected by domain specific parameters and considerations. For example, in the context of business establishment reviews, domain specific parameters 113 may provide that the sentiment score 104 of salient terms 111 that appear at the beginning portion of the text content are to weigh more than the sentiment scores of terms that appear at the end of the item of content.

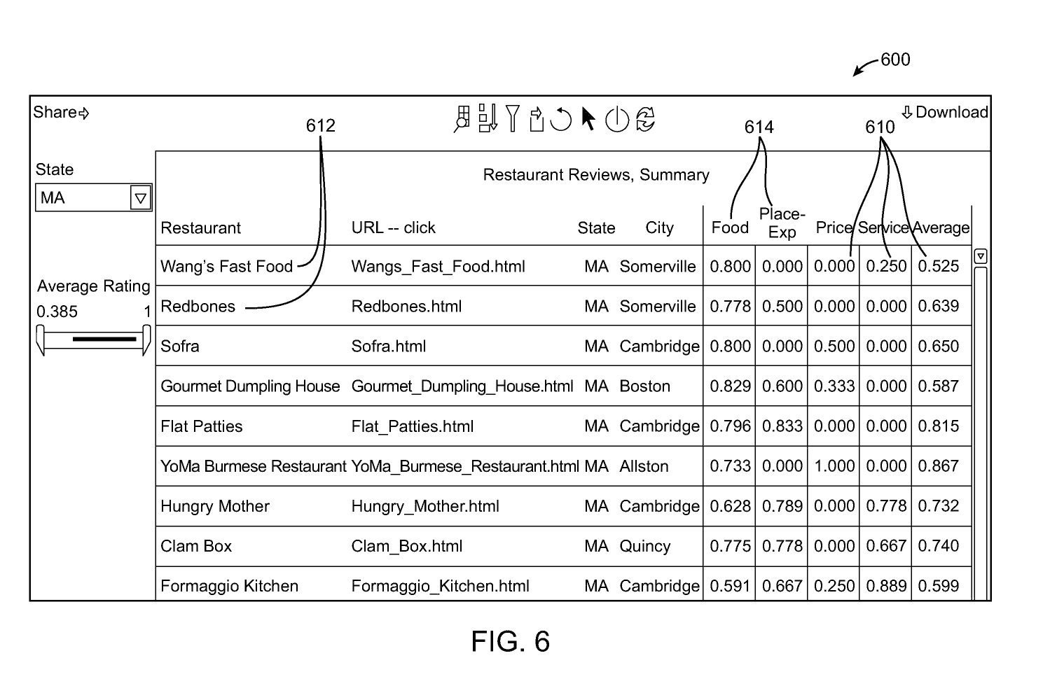

In some implementations, an interface 142 enables access by other components to the output for individual items of text content. In one embodiment, a presentation component 150 accesses the output 118 in order to generate representative content or presentation features that are based on a particular user sentiment. In some implementations, a presentation feature 154 generates a display feature (e.g. icon) from a determined sentiment. The display feature can be associated with the text content 105 that was analyzed. For example, the presentation feature 154 may generate emoticons (animated faces or expressions of emotion) automatically based on the terms and programmatically perceived context of a given item of text content (e.g. message, commentary posted on a website, consumer review or feedback, social networking feed etc.). As an alternative to emoticons or other qualitative expressions of sentiment, some embodiments include displaying sentiment features that are quantitative, such as sentiment scores (e.g. see FIG. 6).

Alternatively, the subject of the analysis may be associated with the feature. For example, consumer reviews of restaurants (or other business establishments) or food items (e.g. wines) may be evaluated for sentiment. The reviews may by parsed at the individual user or author record level, to temporarily opinion level sentiment prior to aggregation. The sentiments may be quantified and tallied in a manner that reflects an overall sentiment of customers for that restaurant. A feature that represents an overall (or average) sentiment of an online population that has provided a review for the particular subject may be presented adjacent to information or advertisement for that subject (e.g. restaurant or food item). For example, restaurants that receive rave user reviews and enthusiastic support from visitors may have information presented with an iconic expression that reflects the enthusiastic customer sentiments. Likewise, restaurants that received mediocre reviews may be presented with information that reflects the mediocre sentiments. Alternative variations include presenting scores of one or more kinds of sentiments based on aggregated totals from various items of content (e.g. aggregation and average of multiple user reviews).

As an alternative or addition to feature presentation, some embodiments may rank subjects of user content by sentiment. For example restaurants can be ranked by categories and sentiment, with restaurants that have the most enthusiastic support being ranked higher than those that have more mediocre sentiment. The rankings may be presented to users in a variety of ways, such as a top list (e.g. top-ten list) of restaurants that people love in a given geographic region. Examples of subjects that can be ranked include business establishments and products. Furthermore the rankings may be specific to specific facets or categories of the business establishments and/or products. For example, restaurants may be ranked by ambience, quality of food, or service. To rank based on sentiment, the sentiment values 123 for the subjects 121 (and/or it subcategories 125) can be tallied and averaged, or otherwise processed in order to determine rankings.

As mentioned, system 100 may be implemented as a programmatic service that provides output 118 to other sites or components. As such, the presentation component 150 may be part of another system, or under control of another entity altogether. System 100 may include a programmatic interface to receive, for example, function calls from another site or programmatic component. The call can specify an input text to be analyzed, an output format, and a subject domain (if one exists, else one may be made). Text content identified from the requesting site/component may then be analyzed as described. The tagged text along with other metrics may comprise the output 118.

Methodology

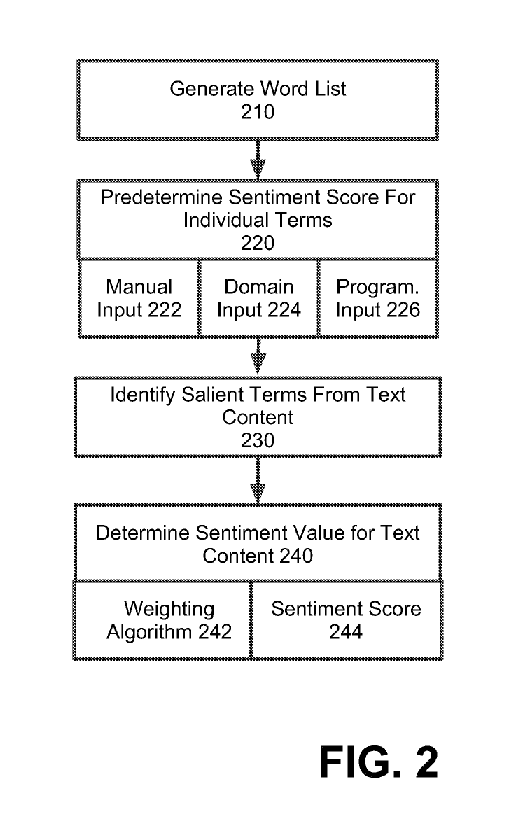

FIG. 2 and FIG. 3 each illustrate a method for determining sentiment from user generated text content, according to one or more embodiments. A method such as described by FIG. 2 or FIG. 3 may be implemented using a system such as described with an embodiment of FIG. 1. Accordingly, reference may be made to elements of prior embodiments for purpose of describing a suitable element or component for implementing a step or sub-step being described.

A word list comprising salient terms may be generated for particular contexts or subject (210). A sentiment score may be determined for individual entries of the word list (220). The sentiment score of individual terms can be determined or affected from manual input (222), domain input (224) and/or programmatic input (226). Manual input 222 may also coincide with using surveys or crowd sourcing in order to gauge or understand the sentiment behind a word. For example, trendy terms may best be understood by analyzing or receiving input from a given population of users as to the emotional meaning behind the term.

The domain input (224) may influence or structure various aspects for determining sentiment scores of individual terms or expressions. The word list from which predetermined sentiment scores are determined may include terms or words that are domain-relevant. For example, wine reviews (domain: wine tasting) may include terms such as “bold” and “legs” which are not as relevant to, for example, the domain for restaurant reviews. Additionally, the domain input (224) may affect the sentiment score of a particular word by considering the meaning of a word or term in the context of the domain (food reviews). A word or expression that can have multiple meanings (e.g. “rich”) may be designated to have the meaning (and associated sentiment score) that is most relevant to the domain. Domain input (224) may also recognize, for example, that in some context, some words carry more enthusiasms, or a sentiment that is contrary to the term's popular use.

Programmatic input 226 can also be used to identify entries for word lists or sentiment scores. In an embodiment, a programmatic process can be implemented to scrape text from various sources, such as social network sites and user reviews, in order to understand the affect reflected in the term. For example, many sources exist online where users can provide a “thumbs up” or rating for a particular subject. Some terms that are used in providing positive and negative feedback may be aggregated and associated with a sentiment that is reflected by the quantified feedback in the various online environments.

Still further, in some embodiments, a combination of programmatic and manual input may be used to identify word entries and respective sentiment scores. In one implementation, an interactive tool may be employed to score and modify a word list for a particular domain. Manual input may score terms of the word list, based on understanding of sentiment carried by the individual term (which may require additional input/analysis from sources such as dictionaries and social network sites).

According to some embodiments, the word list and associated sentiment scores are stored in a data structure for use when analysis of the text content is performed. Analysis of the text content can identify salient terms (230), which include those terms that are candidates for conveying user sentiment. The salient terms may also include a subject of the text content (e.g. business establishment). Category expressions may also be employed to determine terms that are specific to a category of the subject (e.g. price, ambiance).

One or more sentiment values 240 are determined for the analyzed text content. The sentiment value determination may be algorithmic, and take into consideration factors such as frequency of positive and negative terms occurring near the subject of the text content. In some implementations, the individual sentiment scores of the terms (if available) may also be aggregated, and optionally weighted to account for proximity to the subject. An overall sentiment value 240 may reflect the user-sentiment for a particular subject, such as for a particular restaurant or wine. In some embodiments, other sentiment values may reflect the user sentiment for aspects of the subject, such as pricing or taste. In determining the sentiment values, the sentiment score 244 for select salient terms may be determined. Algorithmic input, such as weighting or other calculations, may also be employed to calculate a sentiment value reflecting user sentiment for the subject or category of the content, based on the sentiment score of individual terms.

With FIG. 3, a method is described for determining sentiment values of text content generated pertaining to particular subjects. The subjects of the domain can be predetermined (310). For example, in one implementation, the subjects of the domain correspond to restaurants in a particular geographic region. The subjects of the domain may correspond to the proper names of the restaurants. Similarly, for wines, the subjects of the domain correspond to the names of wines.

The word list for the domain of the subjects may be predetermined (320). The word list may correspond to terms and expressions that are typically used to convey sentiment in the particular topic or general category of the subjects. For example, for restaurant reviews (domain), the word list may comprise of expressions typically used to convey sense of taste, smell, well-being, happiness etc. The sentiment score for individual words or terms may be predetermined (330).

As mentioned with other embodiments, the word list and/or sentiment score can be determined from manual input, or alternatively, from programmatic input (e.g. scraping and analysis of text from reviews along similar domains, from social network sites etc.). The word list and/or sentiment scores may also be determined from surveys and crowd-sourcing.

The text content is processed to determine what the user is expressing sentiment for at various instances in the content. In particular, the user's sentiment may be related to (i) a subject of the content as a whole (e.g. business establishment), (ii) the subject category, such as specific characteristics or aspects of the subject as it pertains to the domain (e.g. pricing of food items for Joe's Bistro in domain of restaurant), or (iii) sentiment that is off-topic or not specific to the subject of the user's content (e.g. “anyone notice much beef costs nowadays?!”).

Accordingly, in determining user sentiments, one or more embodiments perform term identification (340). The terms that are identified can relate to the subject of the text content (342), categories of the subject/domain (344), terms of sentiment (words or expressions that are associated with a particular sentiment) (346).

In connection with term analysis, one or more embodiments utilize relevance analysis in order to identify the relevance of terms of sentiment to terms of subject or domain categories (350). Relevance analysis can be identified independently or integrally with term identification. Relevance analysis identifies what subject or subject category (if any) a sentiment expression is expressed for.

In order to determine relevance of the sentiment terms to subject or subject category, one or more embodiments implement grammatic analysis and/or rules (352). In particular, an embodiment utilizes clausal analysis to identify sentences and clauses in the user's text content. The identification of sentences/clauses provides a mechanism to determine what expressions of user sentiment relate to. For example, in the user review for a restaurant, the user's expression of “fantastic” could refer to the overall experience, the food or the price. Sentence and clausal structures can be identified form the text to determine whether the expression is most relevant to the subject or the subject category.

According to some embodiments, sentences/clauses can be identified as modal with presence of words that are conditional (e.g. “if”, “would”, “might have been”). Such clauses typically reflect sentiment to a noun of the clause. Other clauses that can be identified from content include dependent clauses, which include specific expressions that signify the presence of a dependent clause. The presence of sentiment terms in such clauses also can carry direct relevance to the noun expressed in the clause.

In addition to clausal analysis, certain rules may be implemented to determine the relevance or significance of certain terms. For example, a grammatical rule may correspond to one word sentences that use terms of strong sentiment, such as “Fantastic!”. The presence of such sentences may be predetermined by rule for specific treatment as to relevance and context.

In addition to grammatical analysis, proximity of a sentiment term to the subject (or its category) may also reflect the user's sentiment for the subject or category (354).

A subject-sentiment scoring algorithm is implemented to determine one or more sentiment values that characterize the user sentiment for the subject, or relevant domain specific categories pertaining to the subject. Specifically, various sentiment values are determined at the level of the domain category, by article and/or by author (360). As mentioned with other embodiments, the sentiment value may reflect the user's overall sentiment, or the user's sentiment for a particular aspect of the subject. The sentiment valuation algorithm may utilize various parameters and metrics in determining the sentiment value for the subject or subject's domain category. Individual terms of sentiment may, for the given domain, be associated with a sentiment score that can reflect like/dislike and/or other sentiments (362). The valuation algorithm may, for example, use summation, weights or other formulations in order to determine the score of the user's sentiment for the subject or the domain category of the subject.

In addition to scoring, the sentiment valuation may also include use of term frequency (364), which identify whether a particular term has been used once, twice or more in the content.

Another parameter for determining sentiment includes word pairing (366). In particular, the sentiment carried by some terms may better be understood and quantified using word pairing. Word pairings correspond to two or more words that appear together, in the same sentence or sufficiently proximate to one another to assume they can be paired. Requirements may be stored as for spacing terms, depending on the particular word and/or domain. As an example, in the context of restaurant reviews, the following word pairs are examples of terms that can be assumed to convey sentiment as a result of the pairing: bad: experience; great: meal; absolutely: fantastic; ultra: fresh; best: dinners; final: bill; little: expensive; memorable: delicious. The pairings may convey sentiment about the experience as a whole (e.g. bad: experience), or about a particular category of the subject (e.g. great: meal or little: expensive). The word pairings may carry a sentiment value for a particular sentiment. Alternatively, individual words in the pairing may carry the sentiment value, or carry different sentiment value if the word pairing is present. Still further, the word pairing may verify sentiment value for a particular sentiment, rather than separately scored a sentiment. In variations, word pairing can also be used to determine relevancy of a term of sentiment.

In implementations where the sentiment is singular in dimension, the sentiment value may reflect the score for that particular sentiment (e.g. happiness). In other implementations where the sentiment can be of different types, the word pairings may carry a sentiment value that is associated with a particular type of sentiment (e.g. disgust, sad, angry, fear and happy).

The sentiment score for the individual terms can be averaged, weighted or otherwise tallied in determining the sentiment value associated with the subject (or subject category) (368).

Expressions of Sentiment Value and Presentation

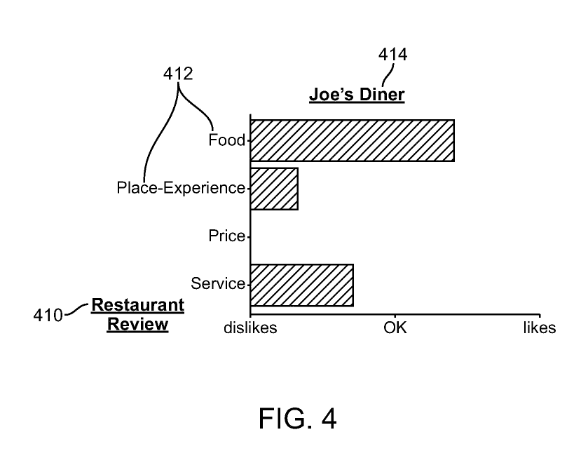

FIG. 4 illustrates a sentiment determination for predetermined categories that are relevant to a domain and subject, according to one or more embodiments. In the example provided, the domain 410 may correspond to one in which restaurants are reviewed and discussed in an online forum. The predetermined categories 412 for the domain can include, for example, food, place experience, price, and service. For a given subject 414 (e.g. Joe's Diner), sentiment from one or more user reviews or commentaries may be used to determine category-specific sentiments. In one implementation, graphical representations may be used to display the identified sentiment for the particular category. Moreover, in the implementation provided, the sentiment is described between a range of affects that includes dislike (negative), OK (neutral), and likes (positive). In such an implementation, the sentiment may be considered to be of a one-dimensional value that correlates to happiness (or like/dislike in). The sentiment determination for different subcategories may be represented for single user, or for multiple users. In the latter case, sentiment values for the particular subject 414 (Joe's diner) may be aggregated and tallied by, for example, using an averaging process.

FIG. 5 illustrates a sentiment determination for subjects of a given domain, where the sentiment determination is multidimensional to include values for different sentiments, according to another embodiment. As with the example of FIG. 4, the domain may correspond to one in which restaurants are reviewed and discussed in an online forum. In the example shown, the different sentiments correspond to disgust, sadness, angry, fear, and happiness. Other sentiments may be used or substituted for those shown. Based on the sentiment analysis performed on the user-text content, different values may be associated with each of the different types of sentiments. In one embodiment, each type of sentiment value associated with the text content may be based on a sentiment value determined from terms used in the text (when such terms are considered with other algorithmic considerations, such as proximity to subject and/or word pairings). Thus, for example, one article may contain multiple sentiment values, based on sentiment scores of individual terms for different types of sentiments.

FIG. 6 illustrates a presentation generated to provide the terminations of sentiment value in context of individual subjects, according to one or more embodiments. An embodiment such as shown may be implemented on a domain for user reviews of business establishments, and more specifically, for restaurant reviews. Embodiments may alternatively be implemented on numerous other domains for subjects, such as wine reviews, food reviews, literary or movie reviews, and user commentary (e.g. in connection with news items or social network). In the example provided, individual business establishments are listed by name and information for a particular geographic region. A system such as described with FIG. 1 may be implemented to determine sentiment values associated with subjects as expressed in user generated text content. As mentioned with other examples, user generated text content may be determined from user reviews and commentary, blogs, social networking sites, or other forms of online media. Individual subjects (e.g. restaurant) may have a collection of, for example, user reviews. Each user generated text content (e.g. review) may be analyzed for sentiment, using for example sentiment scores associated with words or word pairings included in the article. As described with the methodology and embodiments above, the individual sentiment scoring for worse may be weighted, averaged or otherwise prioritized based on, for example, proximity of the sentiment caring terms to the subject of the content, as well as placement, frequency of sentiment terms and other metrics.

In some embodiments, the subject of the user generated text content is programmatically determined. The subject may correspond to, for example, a proper noun identifying a business establishment. The placement of the proper noun in the context of other terms such as those used in the domain or business establishment may identify the proper noun as the subject of the content.

In addition, categories for understanding the sentiments expressed towards the subject may be categorized using subject or domain specific categories. In the example of restaurant reviews, the subject or domain specific categories include food, experience, price, service, an overall sentiment value. As described with other embodiments, certain terms that are deemed to carry sentiment in the particular domain may be pre-associated with the particular category. For example, in the context of restaurant reviews, the term “slow” may be associated with the category of service (e.g. a low value or happiness score for that particular subcategory). Likewise, terms such as “delicious” may be associated with the category of food. As an addition or alternative, word pairings may be used to associate sentiment carrying terms to a particular predetermined category. Still further, word pairings may be used to identify both magnitude and category of the user sentiment.

With further reference to an embodiment of FIG. 6, a sentiment feature 610 may be generated in the form of a sentiment value. In some implementations, the sentiment value ranges between negative and positive sentiment. In the example provided, multiple sentiment values are determined for each subject 612, with each sentiment value being assigned to a particular category 614. In overall sentiment value may also be determined, either based on the sentiment values of the individual categories or based on an overall sentiment value as determined from corresponding individual text content items. The sentiment values 610 may be used to perform other presentation tasks, such as ranking or rating individual business establishments by sentiment value.

Populace Sentiment Determination for Events

With reference to examples described herein, a populace sentiment can reflect a general sentiment for a subject, based on analysis of text content from a group of persons. While a populace sentiment is determined from user generated text content, the determined sentiment value is not necessarily associated with individual content items (e.g., individual messages or posts), but rather reflects the sentiment of a group (e.g., the relevant population) for the subject at a particular instance in time. By way of example, a populace sentiment can be maintained for a subject as a running score, and this sentiment value can be continuously updated with newly identified or submitted content.

In some embodiments, a populace sentiment can be determined in connection with the occurrence of an event occurring over a duration of time. The particular event can also identify the subject, either directly or indirectly. By way of example, some embodiments provide for determining populace sentiment for online or television programs, in which case the subject can correspond to the program title itself, or to characters or actors that appear in the program. In the example of a broadcast program, the populace sentiment can reflect the sentiment of a population of viewers who watch and generate text content with the program. For example, television and web-based programs generally include message boards where fans can submit messages for the community while watching the event. In the example of the broadcast program, the populace sentiment can reflect a sentiment of a population of relevant viewers over the course of a single episode, or tallied over the course of multiple episodes.

In other examples, in the event of interest can correspond to a posting event, where a news item, video clip or other content item is posted to an online forum and receives commentary. Various time period definitions can be used to set the duration by which the event is defined. For example, the time period of the event can be initiated shortly after the posting, when the posting is detected and commentaries are actively being received at a given forum. The time period for such an event can continue for a pre-determined duration (e.g., one hour), or alternatively, for a time when the commentaries begin to slow in number of submission.

FIG. 7 illustrates a system for determining a populace sentiment of a given subject, according to some embodiments. A system such as described with FIG. 7 can be implemented using, for example, a system of FIG. 1, or alternatively examples such as described with FIG. 2 or FIG. 3.

With reference to FIG. 7, a system 700 includes a first sentiment analysis process 710, a second sentiment analysis process 712, a weighting or verification component 730, and a verification process 730. The first sentiment analysis process 710 can be implemented in real-time (or near real-time) to be responsive to user-generated text content that is submitted to a first online source 702 in connection with the occurrence of an event (e.g., television program). By way of example, the first online source 702 can correspond to a message board maintained for a particular television program, and the first sentiment analysis process 710 can be implemented during the broadcast of the television program. Accordingly, the first sentiment analysis process 710 can scan a designated online source 702 (e.g., website) that is predetermined to be associated with an event of interest (e.g., television programming event), during a time period that includes when the event is ongoing. The first sentiment analysis process 710 can also process the content items just before the event starts and just after it completes.

The first sentiment analysis process 710 obtains user generated text content (“UGTC”) feed 703 from the online source 702. The UGTC feed 703 can correspond to ongoing commentary submitted by various users in regards to the particular event. The sentiment determination process 710 can analyze individual items that comprise the feed 703 in order to determine a sentiment value associated with each item. The sentiment determination process 710 can be implemented using, for example, functionality such as described with system 100, and sentiment determination component 122 in particular (see FIG. 1). As an addition or alternative, the sentiment determination process 710 can be implemented using a method such as described with examples of FIG. 2 and FIG. 3.

In some embodiments, sentiment determination process 710 is seeded or otherwise configured to associate sentiment values (or sentiment scores 711) with a specific subject that is based on the online source 702. For example, in the case when the online source 702 pertains to a television program, the subject can correspond to either the specific episode or the television series itself. Likewise, in the case when the online source 702 is a posted event such as a news item or video clip, the subject assumed for the sentiment determination process 710 can correspond to that of the posting. Accordingly, functionality corresponding to subject determination 716 (e.g., see subject determination component 126 of FIG. 1) can be optional, or implemented with variations that take into account the pre-seeding of the subject for the online source 702. This facilitates the sentiment determination process 710 to determine sentiment values for ongoing commentaries of events in, for example, real-time, meaning that the sentiment scores 711 determined from the online source 702 can reflect a measured group sentiment for the subject at a particular instance.

In some examples, the subject determination functionality 716 can be used to verify that a particular content item is relevant to the predetermined subject. For example, message board postings often include threads which include a message about the topic of conversation (which can correspond to the subject), and follow on threads pertaining to the poster or ancillary items in the post. The subject determination functionality 716 can be implemented to determine if the particular posting is relevant to the topic (or subject) or to an ancillary subject (e.g., the poster).

Still further, the subject determination component 716 can identify subjects of content items in order to detect a new subject of interest that originates from, for example, a monitored online forum serving as the online source 702. By way of example, the event of interest can correspond to a sporting event, and the subject for sentiment analysis can correspond to one or both teams or participants of the event. During the sporting event, another event can occur, such as an action or performance by a specific player which then results in the generation of commentaries pertaining to that separate event. The sentiment determination process 710 can determine a sentiment score 711 for the newly identified subject, so as to track multiple subjects at the same time. The sentiment determination process 710 can further maintain a list of subjects and determined sentiment scores 711. The sentiment determination process 710 can also track the number of instances a subject appears so as to detect when a newly encountered subject becomes significant (e.g., viral).

The sentiment scores 711 determined from the sentiment analysis process 710 can be an instant score, a running score, a tabulated score, and/or other value. The particular format can represent a real-time score that is either representative of a particular duration of time (e.g., the length of the event), or representative of a particular moment in the event (e.g., at the half-way point, or at several discrete instances during the event).

According to some embodiments, a populace sentiment score is determined using the sentiment score 711 determined for the first online source 702 in combination with a sentiment score 713 determined from a second online source 704. The first and second online sources 702, 704 can correspond to, for example, websites provided at either a common network domain or at a different domain. In particular, some embodiments provide for obtaining a real-time score from first source 702, corresponding to an active forum associated with a particular event of the subject. Embodiments further recognize that the real-time score can be subjected to fluctuations and/or be based on inputs that are insufficient as a sample to justify a particular sentiment score. Accordingly, in some embodiments, the second online source 704 is selected to verify and/or weight the sentiment value determined from the first online source 702.

According to some examples, the second source 704 can correspond to a website from a different domain than that of the first source 702. Still further, the second source 704 can reflect a website that has a different population of users who are interested in a particular event or subject of interest.

In an embodiment, the second sentiment analysis process 712 reflects a different instance or variation of the first sentiment analysis process 710. Still further, the second sentiment analysis process 712 can reflect multiple processes, each of which access user generated content from a different online source 704. The functionality described with the first sentiment analysis process 710 can be replicated or modified when implemented with second sentiment analysis process 714.

In one embodiment, the second sentiment analysis process 712 is operated in connection with a search process 708. The search process 708 uses a search term or criteria to search a given online source (or set of online sources) for user generated content items 713. For example, in contrast to the first online source 702, which can be a dedicated forum for the event or subject, the second online source 704 can be non-specific. By way of example, the second online source 704 can correspond to a social network (e.g., FACEBOOK, TWITTER, etc.) or website that publishes user-generated content (e.g., REDDIT). The search process 708 can specify the search term, as well as other parameters (e.g., time line) for obtaining UGTC 709 pertaining to the subject in the given time period. As an alternative or addition, the search process 708 can be tuned for a specific forum or site that is highly relevant or pertinent to the subject of interest.

The second sentiment analysis process 712 can analyze individual items that comprise the UGTC 709 in order to determine a sentiment score 713 associated with each item. As with the first sentiment analysis process 710, the second sentiment process 712 can be implemented using functionality such as described with sentiment determination component 122 of system 100 (see FIG. 1), or methods such as described with examples of FIG. 2 and FIG. 3. The second sentiment process 712 can also implement subject determination functionality 726 to verify that a particular content item is relevant to the subject specified for the search process 708.

While an example of FIG. 7 primarily describes second sentiment analysis process 712 as accessing the second online source 704, variations provide that multiple alternative online sources are accessed for sentiment analysis in order to verify a real-time determination of sentiment value from the first online source. Thus, the second sentiment analysis process 712 can be implemented as multiple processes, each of which access a corresponding online source for user generated text content.

The weighting/verification component 730 combines the sentiment scores 711, 713 from the multiple sources in order to determine the populace sentiment value 715. In some embodiments, the first sentiment score 711 is a running score or a set of multiple scores from a large number of content items in a given duration. The second sentiment score 713 can reflect the same time period, or a prior time period (e.g., historical). The second sentiment score 713 can further be determined from an online source that is relevant over a larger span of time. The second sentiment score 713 can reflect sentiment values determined from the same event, but over a duration of time that significantly exceeds the duration of the event when the first sentiment score 711 is determined. For example, the first sentiment score 711 can be determined for a television program while the program is being broadcast. The second sentiment score 713 can be determined from postings on other forums that were recent but which predated the event (e.g., television broadcast), such as, for example, postings that reflect recent historical sentiment for the subject. Still further, the second sentiment score 713 can be determined from other sources in hours or even days after the program is first broadcast.

In some variations, the first and/or second sentiment scores 711, 713 can be weighted relative to one another to reflect, for example, a general belief or understanding regarding sentiment expressed with the respective online source. For example, the second sentiment score 713 can be weighted to reflect that much of the content used to determine the second sentiment score 713 is older or less recent. Expert input can also be used to reflect a general nature of a user population for a particular source being more positive or negative. Still further, the second sentiment score 713 can be used to verify the sentiment score 711 determined from the first sentiment analysis process 710. The verification process can include keeping the first sentiment score 711 when the first and second sentiment scores 711, 713, as measured in a given instance or duration, are within a designated threshold. Else the verification process can provide for either discarding the first sentiment score, or weighting the first sentiment score 711 to reflect the second sentiment score 713. In this way, for example, the verification/weighting component 730 can (i) verify the first sentiment score 711 using the second sentiment score 713, (ii) weight the first sentiment score 711 with the second sentiment score 713, and/or (iii) average the first sentiment score 711 and the second sentiment score 713.

The weighting/verification component 730 can determine the populace sentiment 715 for rendering to users, editors or other class of users (e.g., television programmers). The presentation component 740 can render content that includes the populace sentiment 715 in various forms, including a real-time value, a real-time running value, and as a historical value. Still further, in some variations, the presentation component 740 can identify subjects that may be trending as a result of receiving content with sentiment in a given time period.

In some embodiments, system 700 can include a viral detector 736. The viral detector 736 can execute or interface with at least the first sentiment analysis process 710 in order to determine (i) a subject that receives mention in UGTC 703 exceeding a threshold, and (ii) a real-time sentiment value that exceeds a score threshold. The real-time sentiment value can reflect a running score. When pre-determined thresholds are exceeded, a viral detection trigger 137 can be signaled to, for example, the presentation component 740. The number of instances in which the subject is mentioned, as well as the magnitude of the score can reflect a sentiment velocity. In some variations, when the sentiment velocity exceeds some threshold, the viral detection can also result in the viral detection trigger 737. The presentation component 740 can display the subject of the viral detection trigger 737, along with the populace sentiment 715 of the subject.

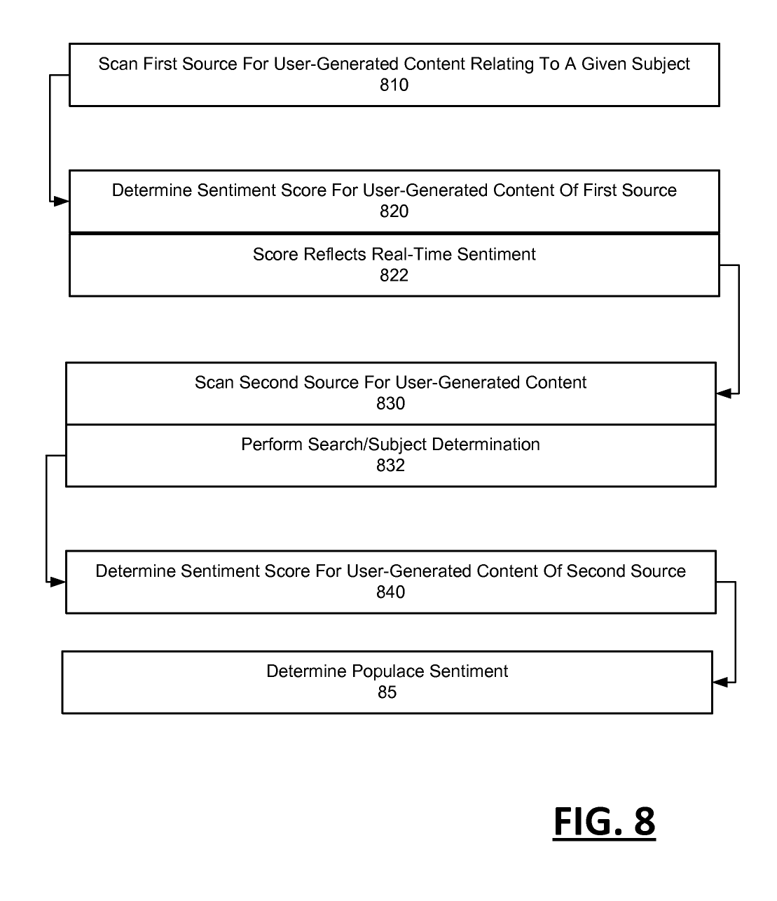

FIG. 8 illustrates a method for determining a populace sentiment, according to some embodiments. A method such as described with an example of FIG. 8 can be implemented using, for example, a system such as described with FIG. 7. Accordingly, reference is made to elements of FIG. 7 for purpose of illustrating suitable components for performing a step or sub-step being described.

With reference to FIG. 8, a first online source is scanned for user-generated text content pertaining to a subject (e.g., even of interest) (810). In one implementation, the subject can be predetermined, and the first online source 702 is selected based on the subject for which sentiment analysis is being performed. For example, it is commonplace for websites and message boards to exist for displaying fan commentary for a television program or event when the program or event is broadcast. In this way, a given website can be selected for sentiment determination based on the website being pre-associated with an event or subject.

The user generated text content from the first online source can be aggregated and analyzed for sentiment values (820). In some embodiments, the sentiment values can be scored to reflect a real-time value (822), such as in connection with the broadcast of the program. The sentiment score can reflect a running total or average, or alternatively a value for a particular instance that is independent of other instance. Furthermore, the score can be based on one or more multiple content items.

According to some embodiments, a set of one or more online sources can also be scanned for user-generated text content pertaining to the particular subject or event of the first online source 702 (830). The selection of the second sources can be based on, for example, a reliability or determination that user-generated content of the subject or event of the first online source 702 will be present with the second online source 704.

As described with an example of FIG. 7, the selected set of online sources can be non-specific as to content items provided (e.g., social network). Thus, the identification of content items relevant to the subject (e.g., event) can include searching and/or subject determination processes (832).

A sentiment score can also be determined for the user generated text content from the selected set of online sources (840). The score determined from the individual source(s) can inherently reflect, for example, pertinent factors for utilizing user generated text content, such as the recency of aggregated messages from which sentiment was derived.

A populace sentiment can be determined from the first sentiment score and the sentiment scores of the set of selected sources (850). According to some embodiments, the first and second sentiment score can be aggregated or otherwise combined to determine the populace sentiment for the particular subject. In one implementation, the sentiment scores from the different sources are averaged. In a variation, the sentiment scores from one source are weighted relative to the sentiment score of another source. The weighting can reflect various considerations, such as the recency of user-generated text content (e.g., second online source may be more stale), the amount of content provided for the particular subject, the quality or confidence of the sentiment determination, etc. The weighting can also reflect editorial input regarding the positivity or negativity of the culture for the particular online source, with some sources being deemed, for example, having users whom are more difficult to please.

Still further, in one embodiment, the first sentiment score is used as a real-time determination, and the second sentiment score is provided to verify the first sentiment score. If the two scores are within a threshold of one another, then the first sentiment score can be used under the premise that the first sentiment is valid. Otherwise, if the sentiment scores are not within a given threshold, then the first sentiment value can be discarded or averaged with the second sentiment score. Thus, while sentiment determined on a real-time basis can be prone to fluctuation, the use of additional sources for sentiment on a given subject can lead credibility to a real-time value.

Computer System

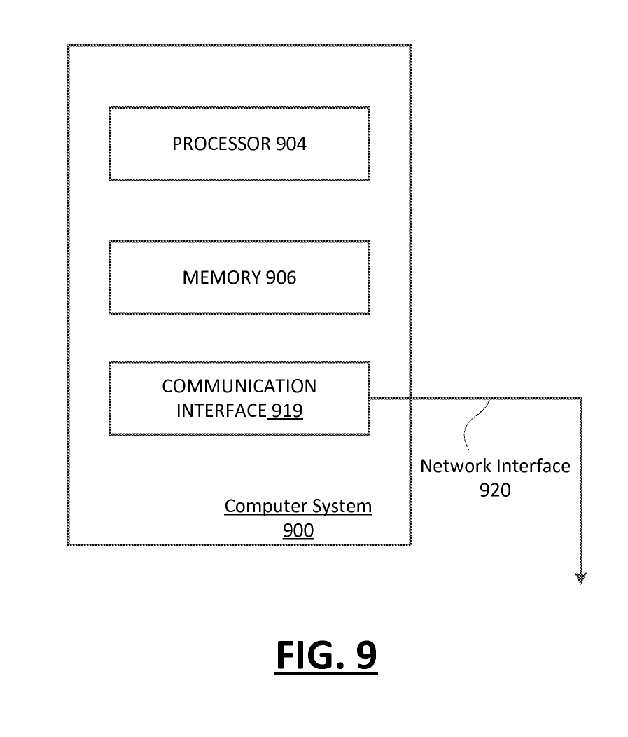

FIG. 9 is a block diagram that illustrates a computer system upon which embodiments described herein may be implemented. For example, in the context of FIG. 1, system 100 may be implemented using a computer system such as described by FIG. 9.

In an embodiment, computer system 900 includes processor 904, main memory 906, ROM 908, storage device 910, and communication interface 918. Computer system 900 includes at least one processor 904 for processing information. Computer system 900 also includes a main memory 906, such as a random access memory (RAM) or other dynamic storage device, for storing information and instructions to be executed by processor 904. Main memory 906 also may be used for storing temporary variables or other intermediate information during execution of instructions to be executed by processor 904. Computer system 900 may also include a read only memory (ROM) 908 or other static storage device for storing static information and instructions for processor 904. A storage device 910, such as a magnetic disk or optical disk, is provided for storing information and instructions.

Computer system 900 can include display 912, such as a cathode ray tube (CRT), a LCD monitor, and a television set, for displaying information to a user. An input device 914, including alphanumeric and other keys, is coupled to computer system 900 for communicating information and command selections to processor 904. Other non-limiting, illustrative examples of input device 914 include a mouse, a trackball, or cursor direction keys for communicating direction information and command selections to processor 904 and for controlling cursor movement on display 912. While only one input device 914 is depicted in FIG. 9, embodiments may include any number of input devices 914 coupled to computer system 900.

Embodiments described herein are related to the use of computer system 900 for implementing the techniques described herein. According to one embodiment, those techniques are performed by computer system 900 in response to processor 904 executing one or more sequences of one or more instructions contained in main memory 906. Such instructions may be read into main memory 906 from another machine-readable medium, such as storage device 910. Execution of the sequences of instructions contained in main memory 906 causes processor 904 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for determining sentiment from user-generated text content, the method being performed by one or more processors and comprising:
processing user-generated content from multiple online sources; and
determining a sentiment value for a subject based on the user-generated content from the multiple online sources;
wherein determining the sentiment value includes associating a weight with at least a first online source of the multiple online sources; and
generating an output indicating the sentiment value.

2. The method of claim 1, wherein generating the output includes averaging a sentiment value from the first online source with a sentiment value of the second inline source.

3. The method of claim 2, wherein the first online source is of a first domain, and the second online source is of a second domain.

4. The method of claim 2, wherein at least the first online source provides user-generated content item responsively in connection with an event associated with the first online source, and wherein determining the sentiment value includes determining the sentiment value for a subject associated with the event in near real-time.

5. A method for determining sentiment from user-generated text content, the method being performed by one or more processors and comprising:
processing user-generated content provided at a first online source from a first plurality of users;
determining a first sentiment value for a subject based on the user-generated content of the first online source;
processing user-generated content provided at a second online source from a second plurality of users;
determining a second sentiment value for the subject based on the user-generated content of the second online source; and
determining a populace sentiment for the subject based on the first sentiment value and the second sentiment value.

6. The method of claim 5, wherein the populace sentiment is based on an average or weighted average of the first sentiment value and the second sentiment value.

7. The method of claim 6, wherein determining the populace sentiment includes assigning a weight to at least one of the first sentiment value or the second sentiment value based on a pre-determined weight associated with one of the first online source or second online source.

8. The method of claim 7, wherein the pre-determined weight associated with one of the first online source or second online source reflect an observed sentiment tendency for user-generated content of either the first online source or the second online source.

9. The method of claim 5, wherein the subject is pre-determined as a current event that occurs over a duration of time, and wherein processing user-generated content provided at the first online source includes processing, in near real-time, user-generated content which is created responsive to progression of the current event towards completion in the duration of time.

10. The method of claim 9, wherein determining the first sentiment value includes determining a preliminary sentiment value for the subject at individual instances in the duration based on the user-generated content provided at the first online source.

11. The method of claim 10, wherein processing user-generated content provided at the second online source includes processing historical user-generated content relating to a past event that is related to the current event.

12. The method of claim 11, wherein determining the populace sentiment includes validating the first sentiment value based on the second sentiment value.

13. The method of claim 11, wherein determining the populace sentiment includes modifying the first sentiment value based on the second sentiment value.

14. The method of claim 11, wherein determining the populace sentiment includes measuring a sentiment velocity or strength from the user-generated content at the first online source.

15. The method of claim 14, further comprising flagging the event as being a viral online candidate when the sentiment velocity or strength exceeds a threshold.

16. The method of claim 11, wherein the first online source corresponds to a message board provided with a programming event for a series, and wherein the second online source pertains to the series.

17. A computer system comprising:
a memory that stores a set of instructions; and
one or more processors that use the set of instructions to:
process user-generated content from multiple online sources; and
determine a sentiment value for a subject based on the user-generated content from the multiple online sources;
wherein the one or more processors determine the sentiment value by associating a weight with at least a first online source of the multiple online sources; and
generating an output indicating the sentiment value.

18. The computer system of 17, wherein the one or more processors generate the output by averaging a sentiment value from the first online source with a sentiment value of the second inline source.

19. The computer system of claim 17, wherein the first online source is of a first domain, and the second online source is of a second domain.

20. The computer system of claim 17, wherein at least the first online source provides user-generated content item responsively in connection with an event associated with the first online source, and wherein the one or more processors determine the sentiment value by determining the sentiment value for a subject associated with the event in near real-time.
